(19) United States
(12) Patent Application Publication
(10) Pub. No.: US 2012/0285740 A1
(43) Pub. Date: Nov. 15, 2012

(54) CABLE ASSEMBLY

(75) Inventors: EDMUND J. HALEY, DILLSBURG, PA (US); DAVID R. BAECHTLE, DILLSBURG, PA (US)

(73) Assignee: TYCO ELECTRONICS CORPORATION, BERWYN, PA (US)

(21) Appl. No.: 13/104,485

(22) Filed: May 10, 2011

(51) Int. Cl. H02G 3/00; F16L 3/123

(52) U.S. Cl. 174/70 R; 248/65

(57) ABSTRACT

A cable assembly includes a cable having a cable jacket. A cable stacker couples the cable to a neighboring cable assembly. The cable stacker has a mounting channel. The cable is received in the mounting channel. The cable stacker has a coupler configured to be coupled to the neighboring cable assembly to hold the cable in position with respect to the neighboring cable assembly.

### BACKGROUND OF THE INVENTION

The subject matter herein relates generally to cable assemblies. Cable assemblies include electrical connectors terminated to ends of cables. The cable assemblies may be used in many types of applications, such as in network switches.

In some applications, many cables are routed from a common component, such as a patch panel. The patch panels typically have limited space for routing the cables from the patch panel. Problems arise when many cables are routed behind the patch panel. The cables have a tendency to get tangled and disorganized. Some systems include a rack holding the patch panels that have brackets for holding the cables. However, the brackets only loosely hold many cables therein. The cables still have a tendency to get tangled and disorganized.

Some cable assemblies include clips or other features that secure a pair of cables together. The clips help to organize the cables into pairs, however, the clips are typically integrated into the ferrule immediately behind the electrical connectors. Such clips tend not to help with reducing tangling. In some systems, the cables may be bundled together and held together using straps, such as zip ties. Such straps are separate from the cable assemblies and must be maintained and carried separately by the installer.

A need remains for cable assemblies that may be organized in a cost effective and reliable manner.

### BRIEF DESCRIPTION OF THE INVENTION

In one embodiment, a cable assembly is provided having a cable having a cable jacket. A cable stacker couples the cable to a neighboring cable assembly. The cable stacker has a mounting channel. The cable is received in the mounting channel. The cable stacker has a coupler configured to be coupled to the neighboring cable assembly to hold the cable in position with respect to the neighboring cable assembly.

In another embodiment, a cable stacker is provided having a main body that has a mounting channel formed therein. The mounting channel is configured to receive a cable. The mounting channel has an inner surface that is configured to engage a jacket of the cable. A coupler extends from the main body that is configured to be coupled to a neighboring cable assembly having a neighboring cable to hold the cable in position with respect to the neighboring cable assembly.

In a further embodiment, a cable stacker is provided having a main body that has a mounting channel formed therein. The mounting channel is configured to receive a cable. The mounting channel has an inner surface configured to engage a jacket of the cable. A coupler extends from the main body between a first end and a second end. The coupler has a receiving cavity in the first end and a post extending from the second end. The coupler is configured to be coupled to a neighboring coupler of a neighboring cable stacker by either loading the post into a receiving space of the neighboring coupler or loading a post of the neighboring coupler into the receiving cavity of the coupler to secure the cable stacker to the neighboring cable stacker.

### BRIEF DESCRIPTION OF THE DRAWINGS

FIG. 1 illustrates an electrical system having a plurality of cable assemblies formed in accordance with an exemplary embodiment.

FIG. 2 is a front perspective view of a portion of one of the cable assemblies shown in FIG. 1 showing a cable stacker coupled to a cable of the cable assembly.

FIG. 3 illustrates a plurality of the cable assemblies, with the cable stackers coupled together to form a cable bundle.

FIG. 4 is a front perspective view of an alternative cable assembly having an alternative cable stacker.

FIG. 5 is a front perspective view of another alternative assembly having another alternative cable stacker.

### DETAILED DESCRIPTION OF THE INVENTION

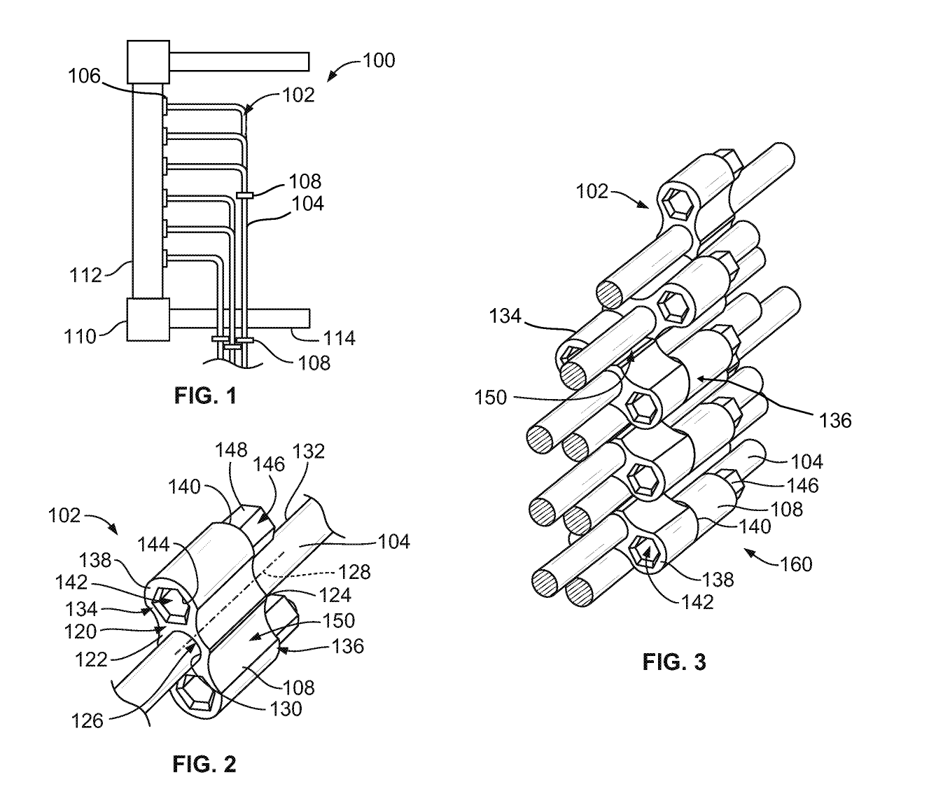

FIG. 1 illustrates an electrical system 100 having a plurality of cable assemblies 102 formed in accordance with an exemplary embodiment. Each cable assembly 102 includes a cable 104 having an electrical connector 106 terminated to an end of the cable 104.

Each cable assembly 102 includes a cable stacker 108 for coupling the cable 104 to a neighboring cable assembly 102. The cable stackers 108 are used to bundle the cable assemblies 102 together. The cable stackers 108 may control the direction and neatness of multiple cables 104 running in limited spaces, such as behind a rack 110. Optionally, the cable stackers 108 may be secured to the rack 110 or another fixed component to fasten the cables 104 in position with respect to the component. The rack 110 may form part of a network switch or patch panel. The cable assemblies 102 may be used without the rack 110 in alternative embodiments. For example, the cable assemblies 102 may be routed in an open space, and the cable stackers 108 may secure the neighboring cable assemblies 102 together to form a cable bundle. The cable stackers 108 neatly organize the cable assemblies 102 by securing the cables 104 together and keeping the cables 104 in parallel alignment in the vicinity of the cable stackers 108. The cable stackers 108 may be positioned at any reasonable location along the length of the cables 104 to organize multiple cables 104 together and/or to secure the cables 104 to another component, such as the rack 110.

In the illustrated embodiment, the electrical system 100 includes a patch panel 112 held by the rack 110. The electrical connectors 106 are coupled to the patch panel 112 for mating with other cable mounted electrical connectors. The cables 104 are routed behind the patch panel 112 to one side 114 of the rack 110. The cable stackers 108 secure the cables 104 together to organize the cables 104 for routing the cables 104 beyond the rack 110.

FIG. 2 is a front perspective view of a portion of a cable assembly 102 showing a cable stacker 108 coupled to the cable 104. The cable stacker 108 includes a main body 120 extending between a first end 122 and second end 124. The main body 120 includes a mounting channel 126 therethrough that extends along a longitudinal axis 128.

The cable 104 is received in the mounting channel 126. For example, during assembly, the cable 104 may be fished through the mounting channel 126 such that the cable 104 extends entirely through the mounting channel 126. In an exemplary embodiment, the mounting channel 126 is a closed channel that entirely circumferentially surrounds the cable 104. The mounting channel 126 has an inner surface 130 that engages a jacket 132 of the cable 104. In an exemplary embodiment, the cable 104 may be loosely received in the mounting channel 126 such that the cable stacker 108 is slidable along the cable 104. As such, the cable stacker 108 may be variably positionable along the length of the cable 104. Optionally, more than one cable stacker 108 may be attached to the cable 104, where the cable stackers 108 are spaced apart from one another to couple to different neighboring cable assemblies 102 or couple to the same neighboring cable assembly 102 along different sections of the cable 104. In an exemplary embodiment, the mounting channel 126 is sized such that the inner surface 130 engages the jacket 132 with a friction fit, to generally hold the relative position of the cable stacker 108 along the cable 104. With enough force, the cable stacker 108 may be slid along the cable 104 to change the position of the cable stacker 108 with respect to the cable 104.

The cable stacker 108 includes a first coupler 134 extending from a first side of the main body 120 and a second coupler 136 extending from a second side of the main body 120. Optionally, the first and second couplers 134, 136 may extend from respective opposite sides of the main body 120.

The first and second couplers 134, 136 may be identical to one another. Alternatively, the first and second couplers 134, 136 may be different than one another. In other alternative embodiments, the cable stacker 108 may only include the first coupler 134 and not the second coupler 136. The first and second couplers 134, 136 are used to secure together the cable stackers 108 of neighboring cable assemblies 102, as shown in FIG. 3. For example, the first coupler 134 may be coupled to a corresponding first coupler 134 of the neighboring cable stacker 108. When the cable stackers 108 of neighboring cable assemblies 102 are coupled together, the cables 104 of the neighboring cable assemblies are held in position with respect to each other.

Each first coupler 134 extends between a first end 138 and a second end 140. A receiving cavity 142 is formed in the first end 138. In the illustrated embodiment, the receiving cavity 142 is hexagonally shaped and includes a plurality of flat sides 144 that are angled with respect to one another. More or less than six sides 144 may be provided in alternative embodiments. In an alternative embodiment, the receiving cavity 142 may not include any sides, but rather may be cylindrical in shape.

Each first coupler 134 includes a post 146 extending from the second end 140. In the illustrated embodiment, the post 146 is hexagonally shaped and includes a plurality of sides 148 that are angled with respect to one another. The post 146 may have more or less sides 148 in alternative embodiments. The shape of the post 146 is complementary to the shape of the receiving cavity 142. The post 146 of one cable stacker 108 is configured to be received in the receiving cavity 142 of a neighboring cable stacker 108 to secure the cable stackers 108 together. Having the posts 146 and the receiving cavities 142 polygonally shaped allows the neighboring cable stackers 108 to be fixed at particular orientations with respect to one another. When the post 146 of one cable stacker 108 is received in the receiving cavity 142 of a neighboring cable stacker 108, the angular position of the one cable stacker 108 is held with respect to the neighboring cable stacker 108.

In an alternative embodiment, the post 146 may be cylindrical and the receiving cavity 142 may also be cylindrical. The cable stacker 108 may be moved relative to the neighboring cable stacker 108 by twisting the post 146 within the receiving cavity 142. The first coupler 134 is thus infinitely variably positionable with respect to the neighboring cable stacker 108.

In an exemplary embodiment, the cable stacker 108 includes a plurality of grooves 150 on an exterior of the main body 120. Each of the grooves 150 is defined by a convex surface sized and shaped to receive a cable 104 of a neighboring cable assembly 102. When the cable stacker 108 is coupled to a neighboring cable stacker 108, the cable 104 of the neighboring cable assembly 102 is nested in one of the grooves 150. This groove 150 helps to maintain the linear path of the cable 104 exiting the neighboring cable stacker 108. The groove 150 provides a space for receiving the cable 104 of the neighboring cable assembly 102 allowing tighter spacing of the cable assemblies 102 when the cable stackers 108 are coupled together.

FIG. 3 shows a plurality of the cable assemblies 102 coupled together to form a cable bundle 160. During assembly, the cable stackers 108 are positioned along the cables 104 by sliding the cable stackers 108 along the cables 104. Once positioned, the cable stackers 108 are coupled together by plugging the posts 146 into the receiving cavities 142 of neighboring cable stackers 108. Some cable stackers 108 may be plugged into the first ends 138, while other cable stackers 108 may be coupled to the second ends 140. As such, a cable stacker 108 may be sandwiched between other cable stackers 108 both in front of, and behind, the cable stacker 108. The cable 104 of the cable assembly 102 is routed along the groove 150 of the neighboring cable stacker 108.

The angular orientation of the cable stacker 108 with respect to the neighboring cable stacker 108 is maintained by the interface between the post 146 and the receiving cavity 142. For example, the cable stackers 108 may be oriented at 45° with respect to one another. Alternatively, the cable stackers 108 may be held at another angular orientation, such as 60°. Having the first and second couplers 134, 136 extending from opposite sides of the main body 120 allows neighboring cable stackers 108 to be coupled to either one side, or both sides, of the cable stacker 108.

Once all of the cable stackers 108 are coupled together, a rigid structure is formed. The cables 104 are held together in a neat, organized manner. The cables 104 are maintained in parallel alignment in the vicinity of the cable stackers 108. The cables 104 are held together as part of the cable bundle 160 which may be handled or manipulated more easily as a unit, rather than as individual cables 104. Additionally, the cables 104 are held tightly together in a small space, allowing more room behind the rack 110 (shown in FIG. 1).

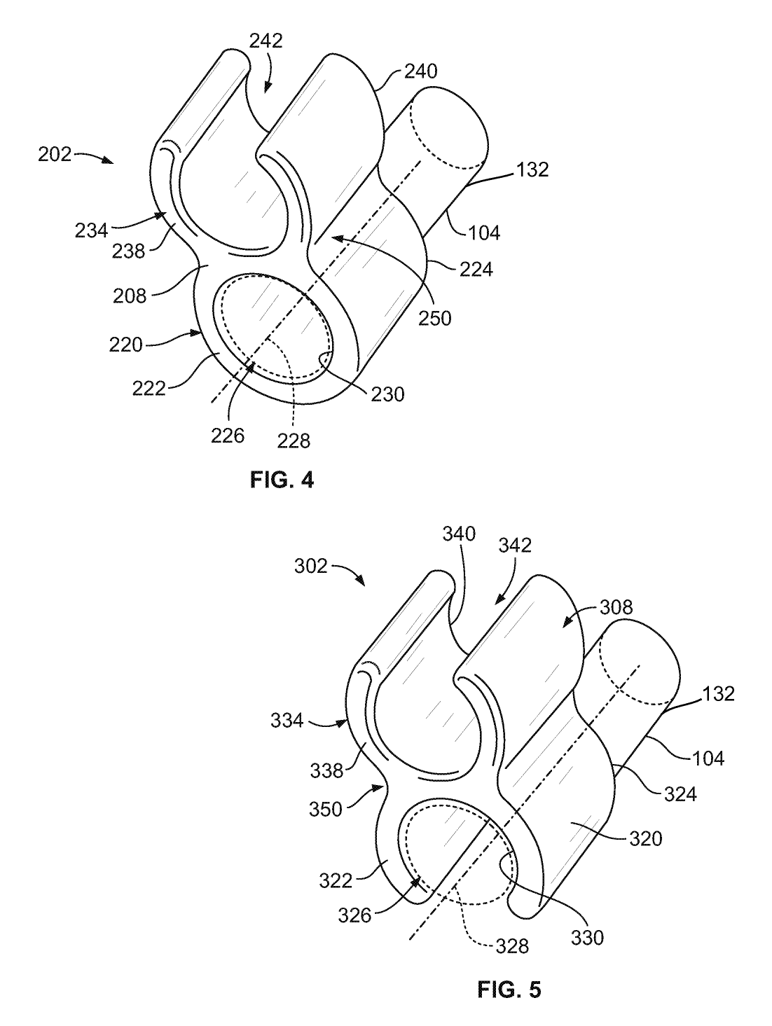

FIG. 4 is a front perspective view of an alternative cable assembly 202. The cable assembly 202 includes a cable stacker 208. The cable stacker 208 includes a main body 220 extending between a first end 222 and a second end 224. The main body 220 includes a mounting channel 226 therethrough that extends along a longitudinal axis 228. The cable 104 is configured to be received in the mounting channel 226. For example, during assembly, the cable 104 may be fished through the mounting channel 226 such that the cable 104 extends entirely through the mounting channel 226. The cable stacker 208 is coupled to the cable 104 prior to the cable 104 being terminated to the electrical connector 106 (shown in FIG. 1).

In an exemplary embodiment, the mounting channel 226 is a closed channel that entirely circumferentially surrounds the cable 104. The mounting channel 226 has an inner surface 230 that engages the jacket 132 of the cable 104. In an exemplary embodiment, the cable 104 may be loosely received in the mounting channel 226 such that the cable stacker 208 is slidable along the cable 104. As such, the cable stacker 208 may be variably positionable along the length of the cable 104.

The cable stacker 208 includes a first cable coupler 234 extending from a first side of the main body 220. The first cable coupler 234 is used to secure the cable stacker 208 to a neighboring cable assembly 202 to hold the cables 104 of neighboring cable assembles 202 in position with respect to each other. Optionally, a second cable coupler (not shown) may extend from a second side of the main body 220. In other alternative embodiments, more than two cable couplers may extend from the main body 220. In other alternative embodiments, the cable couplers may be used to couple the main body 220 to components other than a neighboring cable. For example, the cable couplers may be configured to secure the main body 220 to a fixed structure, such as the rack 110 (shown in FIG. 1) or another component along the path that the cable is routed. The cable coupler may have a different shape to clip to the other component.

The cable coupler 234 extends between a first end 238 and a second end 240. A receiving channel 242 extends through the cable coupler 234. The receiving channel 242 extends between the first and second ends 238, 240. In the illustrated embodiment, the receiving channel 242 is C-shaped. The receiving channel 242 is open sided and is configured to receive a neighboring cable 104 through the open side. The cable coupler 234 may be clipped to the neighboring cable 104 by snapping the opposed legs of the cable coupler 234 around the neighboring cable 104.

In an exemplary embodiment, the cable stacker 208 includes a pair of grooves 250 on an exterior of the main body 220. Each of the grooves 250 is defined by an indented portion sized and shaped to receive a cable 104 of a neighboring cable assembly 202. When a plurality of cable assemblies 202 are bundled together in a cable bundle, each of the cable stackers 208 is coupled to a neighboring cable 104 and each neighboring cable 104 is received in one of the grooves 250. The grooves 250 help to maintain the linear path of the cable 104 exiting the neighboring cable stacker 208. The groove 250 provides a space for receiving the cable 104 of the neighboring cable assembly 202 allowing tighter spacing of the cable assemblies 202 when the cable stackers 208 are coupled together.

During assembly, the cable stackers 208 are positioned along the cables 104 by sliding the cable stackers 208 along the cables 104. Once positioned, the cable stacker 208 is coupled to a neighboring cable 104 by plugging the neighboring cable 104 into the receiving channel 242.

Once all of the cable stackers 208 are coupled together, a rigid structure is formed. The cables 104 are held together in a neat, organized manner. The cables 104 are maintained in parallel alignment by the cable stackers 208. The cables 104 are held together as part of the cable bundle which may be handled or manipulated more easily as a unit, rather than as individual cables 104. Additionally, the cables 104 are held tightly together in a small space, allowing more room behind the rack 110 (shown in FIG. 1).

FIG. 5 is a front perspective view of an alternative cable assembly 302. The cable assembly 302 includes a cable stacker 308. The cable stacker 308 is similar to the cable stacker 208, however the cable stacker 308 includes two open sided channels for receiving cables 104, as opposed to the open channel and the closed channel of the cable stacker 208.

The cable stacker 308 includes a main body 320 extending between a first end 322 and second end 324. The main body 320 includes a mounting channel 326 therethrough that extends along a longitudinal axis 328. The cable 104 is configured to be received in the mounting channel 326.

The mounting channel 326 is C-shaped. The mounting channel 326 is open sided and is configured to receive the cable 104 through the open side. The mounting channel 326 may be clipped to the cable 104 by snapping the opposed legs of the mounting channel 326 around the cable 104. The cable stacker 308 may be variably positionable along the length of the cable 104 by clipping the cable stacker 308 to any portion of the cable 104. The mounting channel 326 has an inner surface 330 that engages the jacket 132 of the cable 104. The cable stacker 308 may be slidable along the cable 104.

The cable stacker 308 includes a first cable coupler 334 extending from a first side of the main body 320. Optionally, a second cable coupler (not shown) may extend from a second side of the main body 320. In other alternative embodiments, more than two cable couplers may extend from the main body 320. The first cable coupler 334 is used to secure the cable stacker 308 to a neighboring cable assembly 302 to hold the cables 104 of the neighboring cable assemblies 302 in position with respect to each other. In an alternative embodiment, the cable coupler 334 may be used to secure the main body 320 to another component other than a neighboring cable, such as the rack 110 (shown in FIG. 1) or another fixed component along the cable route.

The cable coupler 334 extends between a first end 338 and a second end 340. A receiving channel 342 extends through the cable coupler 334. The receiving channel 342 extends between the first and second ends 338, 340. In the illustrated embodiment, the receiving channel 342 is C-shaped. The receiving channel 342 is open sided and is configured to receive a neighboring cable 104 through the open side. The neighboring cable coupler 334 may be clipped to the neighboring cable 104 by snapping the opposed legs of the neighboring cable coupler 334 around the neighboring cable 104.

In an exemplary embodiment, the cable stacker 308 includes a pair of grooves 350 on an exterior of the main body 320. Each of the grooves 350 is defined by an indented portion sized and shaped to receive a cable 104 of a neighboring cable assembly 302. When a plurality of cable assemblies 302 are bundled together in a cable bundle, each of the cable stackers 308 is coupled to a neighboring cable 104 and each neighboring cable 104 is received in one of the grooves 350. This groove 350 helps to maintain the linear path of the cable 104 exiting the neighboring cable stacker 308. The groove 350 provides a space for receiving the cable 104 of the neighboring cable assembly 302 allowing tighter spacing of the cable assemblies 302 when the cable stackers 308 are coupled together.

During assembly, the cable stacker 308 is clipped to one cable 104, and then a neighboring cable 104 is loaded into the receiving channel 342. Once all of the cable stackers 308 are coupled together, a rigid structure is formed. The cables 104 are held together in a neat, organized manner. The cables 104 are maintained in parallel alignment in the vicinity of the cable stackers 308. The cables 104 are held together as part of the cable bundle which may be handled or manipulated more easily as a unit, rather than as individual cables 104. Additionally, the cables 104 are held tightly together in a small space, allowing more room behind the rack 110 (shown in FIG. 1).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A cable assembly comprising:
a cable having a cable jacket; and
a cable stacker for coupling the cable to a neighboring cable assembly, the cable stacker having a mounting channel, the cable being received in the mounting channel, the cable stacker having a coupler configured to be coupled to the neighboring cable assembly to hold the cable in position with respect to the neighboring cable assembly.

2. The cable assembly of claim 1, wherein the mounting channel circumferentially surrounds the cable.

3. The cable assembly of claim 1, wherein the cable stacker is variably positionable along the cable.

4. The cable assembly of claim 1, wherein the mounting channel is C-shaped and includes an open side, the cable being loaded into the mounting channel through the open side.

5. The cable assembly of claim 1, wherein the coupler is a cable coupler configured to directly engage a cable of the neighboring cable assembly.

6. The cable assembly of claim 1, wherein the coupler is configured to be secured to a coupler of the neighboring cable assembly.

7. The cable assembly of claim 1, wherein the coupler extends between a first end and a second end, the coupler having a receiving cavity at the first end, the coupler having a post extending from the second end, the coupler being configured to be coupled to a coupler of the neighboring cable assembly by either loading the post into a receiving cavity of the neighboring coupler or loading a post of the neighboring coupler into the receiving cavity of the coupler to secure the cable stacker to the neighboring cable assembly.

8. The cable assembly of claim 1, wherein the cable stacker includes a main body, the mounting channel being formed in the main body, the coupler extending from a first side of the main body, the cable stacker having a second coupler extending from a second side of the main body, the second coupler being configured to be coupled to another neighboring cable assembly to hold the cable in position with respect to the other neighboring cable assembly.

9. The cable assembly of claim 1, wherein the cable stacker includes a main body, the mounting channel being formed in the main body, the main body having a groove on an exterior thereof, the coupler being configured to be coupled to the neighboring cable assembly such that a cable of the neighboring cable assembly rests in the groove.

10. The cable assembly of claim 1, wherein the coupler comprises a cable coupler having a receiving channel configured to receive a cable of the neighboring cable assembly.

11. The cable assembly of claim 1, wherein the coupler comprises a cable coupler having a C-shaped receiving channel having an open side, the receiving channel being configured to receive a cable of the neighboring cable assembly, the mounting channel comprising one of an O-shaped, closed channel or a C-shaped, open sided channel that receives the cable.

12. A cable stacker comprising:
a main body having a mounting channel formed therein, the mounting channel being configured to receive a cable, the mounting channel having an inner surface configured to engage a jacket of the cable; and
a coupler extending from the main body, the coupler being configured to be coupled to a neighboring cable assembly having a neighboring cable to hold the cable in position with respect to the neighboring cable assembly.

13. The cable stacker of claim 12, wherein the coupler extends between a first end and a second end, the coupler having a receiving cavity at the first end, the coupler having a post extending from the second end, the coupler being configured to be coupled to a coupler of the neighboring cable assembly by either loading the post into a receiving cavity of the neighboring coupler or loading a post of the neighboring coupler into the receiving cavity of the coupler to secure the cable stacker to the neighboring cable assembly.

14. The cable stacker of claim 12, wherein the cable stacker is variably positionable along the cable.

15. The cable stacker of claim 12, wherein the mounting channel is C-shaped and includes an open side, the cable being loaded into the mounting channel through the open side.

16. The cable stacker of claim 12, wherein the coupler is configured to directly engage a cable of the neighboring cable assembly.

17. The cable stacker of claim 12, wherein the coupler is configured to be secured to a coupler of the neighboring cable assembly.

18. A cable stacker comprising:
a main body having a mounting channel formed therein, the mounting channel being configured to receive a cable, the mounting channel having an inner surface configured to engage a jacket of the cable; and
a coupler extending from the main body, the coupler extending between a first end and a second end, the coupler having a receiving cavity in the first end, the coupler having a post extending from the second end, the coupler being configured to be coupled to a neighboring coupler of a neighboring cable stacker by either loading the post into a receiving space of the neighboring coupler or loading a post of the neighboring coupler into the receiving cavity of the coupler to secure the cable stacker to the neighboring cable stacker.

19. The cable stacker of claim 18, wherein the mounting channel circumferentially surrounds the cable, the cable stacker being variably positionable along the cable.

20. The cable stacker of claim 18, wherein the coupler extends from a first side of the main body, the cable stacker further comprising a second coupler extending from a second side of the main body, the second coupler being configured to be coupled to another neighboring cable assembly to hold the cable in position with respect to the other neighboring cable assembly.
